(19) United States
(12) Patent Application Publication
(10) Pub. No.: US 2024/0278570 A1
(43) Pub. Date: Aug. 22, 2024

(54) LIQUID EJECTION DEVICE

(71) Applicant: SEIKO EPSON CORPORATION, TOKYO (JP)

(72) Inventors: Osamu KATSUDA, Matsumoto-shi (JP); Takahiro MATSUZAKI, Shiojiri-shi (JP); Hirokazu SEKINO, Chino-shi (JP)

(21) Appl. No.: 18/443,376

(22) Filed: Feb. 16, 2024

(30) Foreign Application Priority Data
Feb. 17, 2023 (JP) 2023-023697

(51) Int. Cl. B41J 2/145

(52) U.S. Cl. CPC B41J 2/145

(57) ABSTRACT

A liquid ejection device includes an ejector configured to eject a liquid in a continuous flow from an ejection surface of the ejector, form the continuous flow into droplets, and cause a collision with an object in a form of the droplets, wherein, in the ejection surface, a plurality of first nozzle rows each including a plurality of first nozzle holes for ejecting the liquid arranged at first distances in a nozzle hole arrangement direction are arranged, the plurality of first nozzle rows is arranged at second distances in a nozzle row arrangement direction crossing the nozzle hole arrangement direction, and the second distance is equal to or more than twice the first distance.

The present application is based on, and claims priority from JP Application Serial Number 2023-023697, filed Feb. 17, 2022, the disclosure of which is hereby incorporated by reference herein in its entirety.

### BACKGROUND

### 1. Technical Field

The present disclosure relates to a liquid ejection device.

### 2. Related Art

In related art, various liquid ejection devices ejecting liquids to objects are used. The liquid ejection devices include a liquid ejection device ejecting a liquid in a continuous flow, forming the continuous flow into droplets, and causing a collision with an object in a form of the droplets like e.g., a skin cleansing liquid ejection device disclosed in JP-A-2022-128872.

As a method for increasing an ejection area when a liquid is ejected to an object, increase of the number of nozzle holes for ejecting the liquid is considered. For example, like a showerhead in JP-A-2016-104930, a circular arrangement of a plurality of nozzle holes is considered. However, in the liquid ejection device ejecting the liquid in the continuous flow, forming the continuous flow into the droplets, and causing the collision with the object in the form of the droplets, when the liquid hitting the object is accumulated in a small area and a liquid film is formed, the droplets collide with the liquid film and the liquid may not collide with the object with a desired collision force. When the number of nozzle holes for ejecting the liquid is increased, the liquid hitting the object is accumulated and a liquid film is easily formed depending on the configuration.

### SUMMARY

A liquid ejection device according to an aspect of the present disclosure in order to solve the above described problem is a liquid ejection device including an ejector configured to eject a liquid in a continuous flow from an ejection surface of the ejector, form the continuous flow into droplets, and cause a collision with an object in a form of the droplets, wherein, in the ejection surface, a plurality of first nozzle rows each including a plurality of first nozzle holes for ejecting the liquid arranged at first distances in a nozzle hole arrangement direction are arranged, the plurality of first nozzle rows is arranged at second distances in a nozzle row arrangement direction crossing the nozzle hole arrangement direction, and the second distance is equal to or more than twice the first distance.

### BRIEF DESCRIPTION OF THE DRAWINGS

FIG. 1 is a schematic diagram showing a liquid ejection device of Embodiment 1 of the present disclosure.

FIG. 2 is a schematic diagram showing an ejection surface of an ejector of the liquid ejection device in FIG. 1.

FIG. 3 is an enlarged view of the ejection surface in FIG. 2.

FIG. 4 is a schematic diagram showing a state in which a liquid is ejected to an object using the liquid ejection device in FIG. 1 in a plan view of the object.

FIG. 5 is a schematic diagram showing a state in which the liquid is ejected to the object using the liquid ejection device in FIG. 1 in a side view of the object.

FIG. 6 is a schematic diagram showing an ejection surface of an ejector of a liquid ejection device of Embodiment 2 of the present disclosure.

FIG. 7 is a schematic diagram showing an ejection surface of an ejector of a liquid ejection device of Embodiment 3 of the present disclosure.

FIG. 8 is a schematic diagram showing a state in which a liquid film is produced in a hit area of a liquid when a collision of the liquid is caused using a liquid ejection device of a reference example in a side view of an object.

### DESCRIPTION OF EMBODIMENTS

First, the present disclosure will be schematically described.

A liquid ejection device in a first mode of the present disclosure in order to solve the above described problem is a liquid ejection device including an ejector ejecting a liquid and configured to eject the liquid in a continuous flow from an ejection surface of the ejector, form the continuous flow into droplets, and cause a collision with an object in a form of the droplets, wherein a plurality of first nozzle rows each including a plurality of first nozzle holes for ejecting the liquid arranged at first distances are arranged at second distances in a nozzle row arrangement direction crossing a nozzle hole arrangement direction in which the first nozzle holes are arranged in the first nozzle rows, and the second distance is equal to or more than twice the first distance.

According to the mode, the plurality of first nozzle rows each including the plurality of first nozzle holes for ejecting the liquid are provided, and thereby, an ejection area of the liquid may be larger. Further, the second distance as a distance between the first nozzle rows is equal to or more than twice the first distance as a distance between the first nozzle holes, and thereby, the liquid hitting the object may be released to a different area from a hit area of the liquid in the object corresponding to an area between the first nozzle rows. That is, reduction of an impact force of the droplets due to a liquid film formed by accumulation of the liquid hitting the object may be suppressed.

In a liquid ejection device in a second mode of the present disclosure according to the first mode, the first distance is equal to or more than ten times a hole diameter of the first nozzle hole.

According to the mode, the first distance is equal to or more than ten times the hole diameter of the first nozzle hole. According to the configuration, the formation of the liquid film by the accumulation of the liquid hitting the object may be particularly effectively suppressed and the reduction of the impact force of the droplets may be particularly effectively suppressed.

In a liquid ejection device in a third mode of the present disclosure according to the first or second mode, the ejection surface has a ratio of a longer length to a shorter length of a length in which the first nozzle holes are provided in the nozzle row arrangement direction and a length in which the first nozzle holes are provided in a direction orthogonal to the nozzle row arrangement direction is equal to or larger than 1.5.

According to the mode, the ejection surface has the ratio of the length in which the first nozzle holes are provided in the nozzle row arrangement direction to the length in which the first nozzle holes are provided in the direction orthogonal to the nozzle row arrangement direction is equal to or larger than 1.5. According to the configuration, the liquid ejected to the object may be particularly effectively released to a different area from the hit area of the liquid in the object, and the reduction of the impact force of the droplets may be particularly effectively suppressed.

In a liquid ejection device in a fourth mode of the present disclosure according to the first or second mode, in the ejector, a rate of a formation area of the first nozzle holes to an area of the ejection surface is equal to or lower than 1%.

According to the mode, in the ejector, the rate of the formation area of the first nozzle holes to the area of the ejection surface is equal to or lower than 1%. According to the configuration, the formation of the liquid film by the accumulation of the liquid hitting the object may be particularly effectively suppressed, and the reduction of the impact force of the droplets may be particularly effectively suppressed.

In a liquid ejection device in a fifth mode of the present disclosure according to the first or second mode, a hole diameter of the first nozzle hole is equal to or smaller than 150 μm.

According to the mode, the hole diameter of the first nozzle hole is equal to or smaller than 150 μm. According to the configuration, the ejection of the liquid in the continuous flow, the formation of the continuous flow into the droplets, and the collision with the object in the form of the droplets may be particularly preferably executed.

In a liquid ejection device in a sixth mode of the present disclosure according to the first or second mode, in the ejection surface, second nozzle holes having different hole diameters from the first nozzle holes are placed outside of a formation area of the first nozzle holes as seen from an ejection direction of the liquid.

According to the mode, in the ejection surface, the second nozzle holes having the different hole diameters from the first nozzle holes are placed outside of the formation area of the first nozzle holes as seen from the ejection direction of the liquid. According to the configuration, foreign matter with dirt or the like removed from the object by the liquid ejected from the first nozzle holes may be washed away from on the object by the liquid ejected from the second nozzle holes placed around.

In a liquid ejection device in a seventh mode of the present disclosure according to the sixth mode, a flow rate of the liquid per unit time ejected from the second nozzle holes is higher than a flow rate of the liquid per unit time ejected from the first nozzle holes.

According to the mode, the flow rate of the liquid per unit time ejected from the second nozzle holes is higher than the flow rate of the liquid per unit time ejected from the first nozzle holes. Accordingly, for example, the foreign matter with dirt or the like attached to the object may be particularly effectively removed by the liquid discharged from the second nozzle holes.

### Embodiment 1

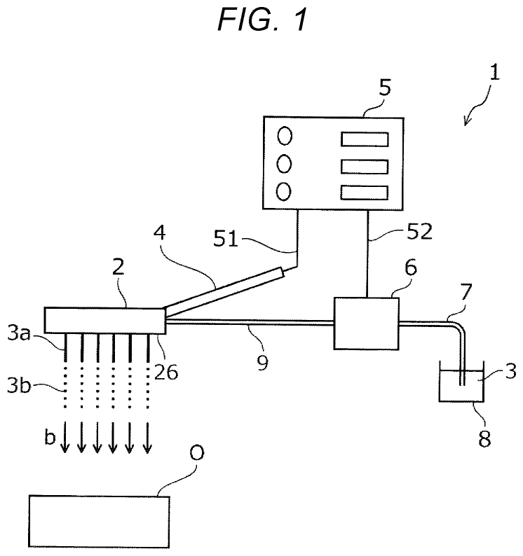

As below, embodiments according to the present disclosure will be explained with reference to the accompanying drawings. First, an outline of a liquid ejection device 1 according to Embodiment 1 of the present disclosure will be explained with reference to FIG. 1. The liquid ejection device 1 shown in FIG. 1 includes a head part 2 as an ejector ejecting a liquid 3, a liquid feed pump 6 feeding the liquid 3 to be ejected, a tank 8 reserving the liquid 3 to be ejected, a liquid suction tube 7 connecting the tank 8 and the liquid feed pump 6, and a liquid feed tube 9 connecting the liquid feed pump 6 and the head part 2. Further, the liquid ejection device includes a controller 5 having a drive signal line 51 to the head part 2 and a control signal line 52 to the liquid feed pump 6.

A user performs various kinds of work by gripping a grip part 4, ejecting the liquid 3 from the head part 2, causing a collision of the liquid 3 with a desired object O using the liquid ejection device 1 having the above described configuration. Various kinds of work include e.g., medical application such as dental therapy and cleansing, burring, peeling, chipping, excision, incision, fracturing, or the like on objects. The liquid ejection device 1 of the embodiment is a liquid ejection device including the head part 2 as the ejector ejecting the liquid 3 and causing a collision of droplets 3b formed from a continuous flow 3a of the liquid 3 continuously ejected from an ejection surface 26 of the head part 2 in an ejection direction b with the object O in a form of the droplets 3b.

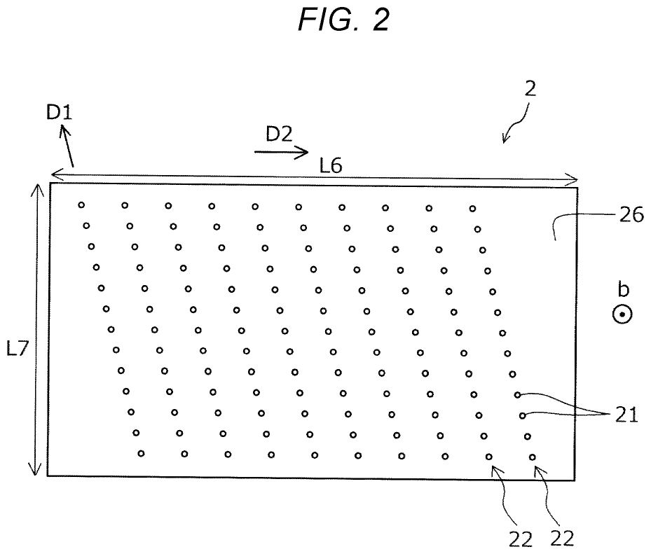

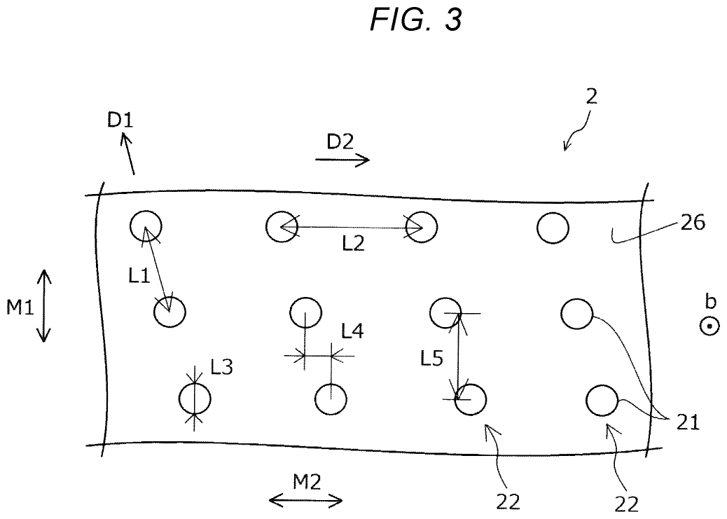

Next, the head part 2 as a main part of the liquid ejection device 1 will be specifically described with reference to FIGS. 2 to 5. As shown in FIGS. 2 and 3, a plurality of first nozzle holes 21 for ejecting the liquid 3 are provided in the ejection surface 26 of the head part 2 of the embodiment. As shown in FIG. 3, the first nozzle holes 21 are arranged along a direction D1 at first distances L1, the plurality of first nozzle holes 21 are arranged in the direction D1, and thereby, first nozzle rows 22 are formed.

Further, as shown in FIG. 2, the plurality of first nozzle rows 22 are arranged in a direction D2 on the ejection surface 26 of the head part 2 of the embodiment. Specifically, as shown in FIG. 3, the plurality of first nozzle rows 22 are arranged at second distances L2 in the direction D2 crossing the direction D1 as a nozzle hole arrangement direction in which the first nozzle holes 21 are arranged in the first nozzle rows 22, i.e., a nozzle row arrangement direction. As described above, the plurality of first nozzle rows 22 including the plurality of first nozzle holes 21 for ejecting the liquid 3 are provided, and thereby, the ejection area of the liquid 3 may be increased.

Here, in the head part 2 of the embodiment, the second distance L2 is about twice the first distance L1. As described above, it is preferable that the second distance L2 is equal to or more than twice the first distance L1. The second distance L2 as a distance between the first nozzle rows 22 is equal to or more than twice the first distance L1 as a distance between the first nozzle holes 21, and thereby, the liquid 3 hitting the object O may be released to a different area from the hit area of the liquid 3 in the object O corresponding to the area between the first nozzle rows 22. That is, reduction of an impact force of the droplets 3b due to a liquid film 34 formed by accumulation of the liquid 3 hitting the object O may be suppressed.

Here, a case where the liquid 3 hitting the object O is accumulated and the liquid film 34 is formed in the hit position of the droplets 3b and a case where the liquid 3 may be promptly released from the hit position of the droplets 3b to a different area from the hit position are explained. The case where the liquid 3 hitting the object O is accumulated and the liquid film 34 is formed in the hit position of the droplets 3b corresponds to a case where the liquid 3 hitting the object O is accumulated on the object O, the liquid film 34 is formed, and the impact force of the droplets 3b is reduced. Further, the case where the liquid 3 may be promptly released from the hit position of the droplets 3b to a different area from the hit position corresponds to a case where the liquid 3 may be promptly released to a different position from the hit position of the liquid 3 on the object O, i.e., a position on the object O corresponding to the area between the first nozzle rows 22 and the reduction of the impact force of the droplets 3b is suppressed.

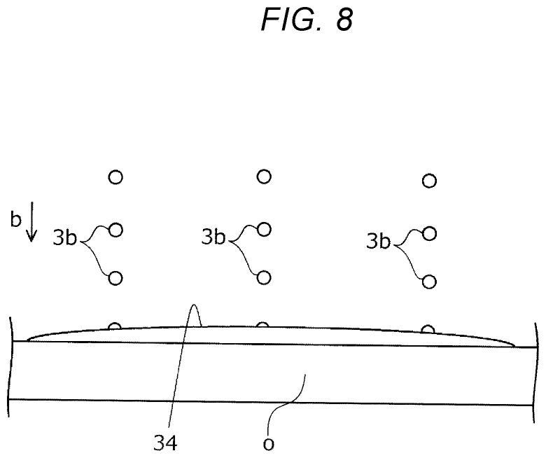

First, a state in which the liquid film 34 is produced in the hit position of the liquid 3 when a collision of the liquid 3 with the object O is caused using a liquid ejection device of a reference example is explained with reference to FIG. 8. As shown in FIG. 8, when density of the nozzle holes is higher, the larger liquid film 34 is produced on the object O. When the larger liquid film 34 is produced, the liquid film 34 is continued to be formed in the hit position of the droplets 3b, and the impact force when the droplets 3b hit the object O is absorbed by the liquid film 34 and it is hard to apply a large impact force to the object O. The impact force of the droplets 3b is absorbed by the liquid film 34, and thereby, for example, when the object O is cleansed, a cleansing force is reduced.

Note that the state in which the liquid film 34 is continued to be formed in the hit position of the droplets 3b as shown in FIG. 8 is particularly caused, for example, when the nozzle holes are circularly arranged and when the distance between the adjacent nozzle holes is smaller and only one nozzle row is provided. When the distance between the adjacent nozzle holes is smaller and only one nozzle row is provided, the droplets 3b hitting the object O may interfere in the area between the droplets 3b ejected from the adjacent nozzle holes in the object O and a film is formed in the area in between and the cleansing force may be reduced.

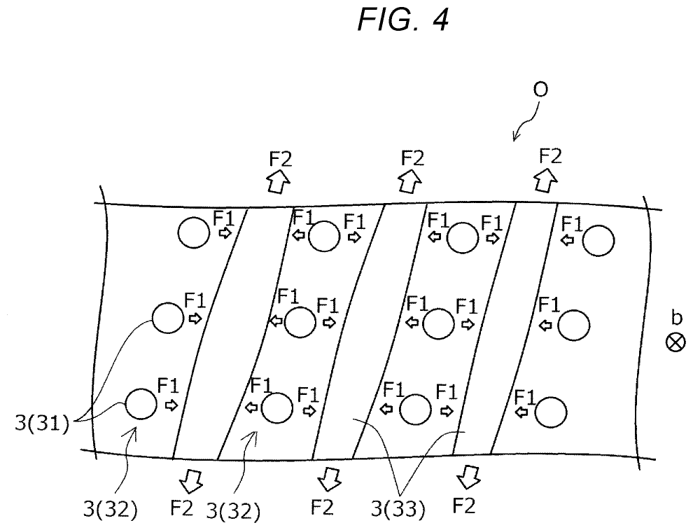

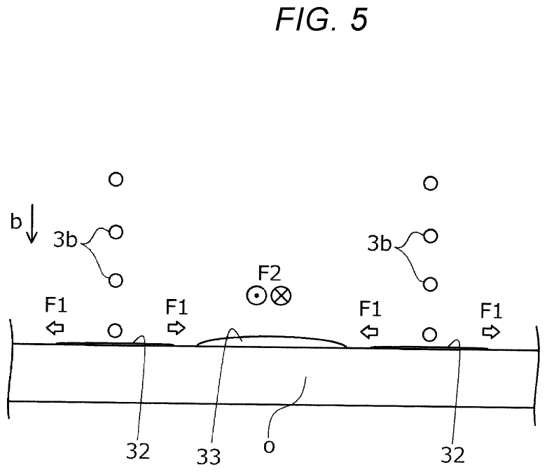

Next, the case where the liquid 3 is promptly released from the hit position of the droplets 3b to a different area from the hit position using the liquid ejection device 1 of the embodiment is explained with reference to FIGS. 4 and 5. When the droplets 3b are allowed to hit the object O using the liquid ejection device 1 of the embodiment, liquids 31 hitting in the hit position spread on the object O. The liquids 31 form arrays 32 corresponding to the first nozzle rows 22 on the object O. Of the liquids 31 hitting in the hit position on the object O, the liquid 3 spreading in a direction F1 becomes integrated with the liquid 3 spreading from the adjacent array 32 and a liquid accumulation 33 is formed in the area between the arrays 32. The liquid 3 of the liquid accumulation 33 flows in a direction F2. As described above, the liquid 3 hitting the object O sequentially continues to flow in the direction F1 and the direction F2, and thereby, formation of the liquid film 34 by the accumulation of the liquid 3 in the hit position of the droplets 3b on the object O is suppressed.

Here, in the liquid ejection device 1 of the embodiment, the first distance L1 shown in FIG. 3 is about ten times a hole diameter L3 of the first nozzle hole 21. As described above, it is preferable that the first distance L1 is equal to or more than ten times the hole diameter L3 of the first nozzle hole 21. According to the configuration, the formation of the liquid film 34 by the accumulation of the liquid 3 hitting the object may be particularly effectively suppressed and the reduction of the impact force of the droplets 3b may be particularly effectively suppressed. Note that the first distance L1 is more preferably equal to or more than twenty times the hole diameter L3 of the first nozzle hole 21, and the first distance L1 is particularly preferably equal to or more than thirty times the hole diameter L3 of the first nozzle hole 21.

Further, in the liquid ejection device 1 of the embodiment, the user may eject the liquid 3 to the object O while moving the head part 2. Here, when the liquid 3 is ejected to the object O while the head part 2 is moved, it is preferable to eject the liquid 3 to the object while moving the head part 2 in a movement direction M1 shown in FIG. 3. The liquid 3 is ejected to the object O while the head part 2 is moved in the movement direction M1, and thereby, the liquid 3 may be efficiently ejected to the object O. When the liquid 3 is ejected to the object O while the head part 2 is moved in the movement direction M1, the droplets 3b may be allowed to hit the object O at a pitch of a distance L4 as a shorter distance. On the other hand, when the liquid 3 is ejected to the object O while the head part 2 is moved in a movement direction M2, the droplets 3b may be allowed to hit the object O at a pitch of a distance L5 as a longer distance. The liquid 3 is ejected to the object O at the shorter distances, and thereby, for example, when the object O is cleansed, a cleansing force is increased.

Here, it is preferable that the ejection surface 26 has a ratio of the longer length to the shorter length of a length L6 in which the first nozzle holes 21 are provided in the direction D2 corresponding to the nozzle row arrangement direction shown in FIG. 2 and a length L7 in which the first nozzle holes 21 are provided in a direction orthogonal to the nozzle row arrangement direction is equal to or larger than 1.5. According to the configuration, the liquid 3 ejected to the object O may be particularly effectively released to a different area from the hit area of the liquid 3 in the object O, and the reduction of the impact force of the droplets 3b may be particularly effectively suppressed.

Further, it is preferable that a rate of the formation area of the first nozzle holes 21 to the area of the ejection surface 26 is equal to or lower than 1%. According to the configuration, the formation of the liquid film 34 by the accumulation of the liquid 3 hitting the object O may be particularly effectively suppressed, and the reduction of the impact force of the droplets 3b may be particularly effectively suppressed.

Furthermore, it is preferable that the hole diameter L3 of the first nozzle hole 21 is equal to or smaller than 150 μm. According to the configuration, the ejection of the liquid 3 in the continuous flow 3a, the formation of the continuous flow 3a into the droplets 3b, and the collision with the object O in the form of the droplets 3b may be particularly preferably executed.

### Embodiment 2

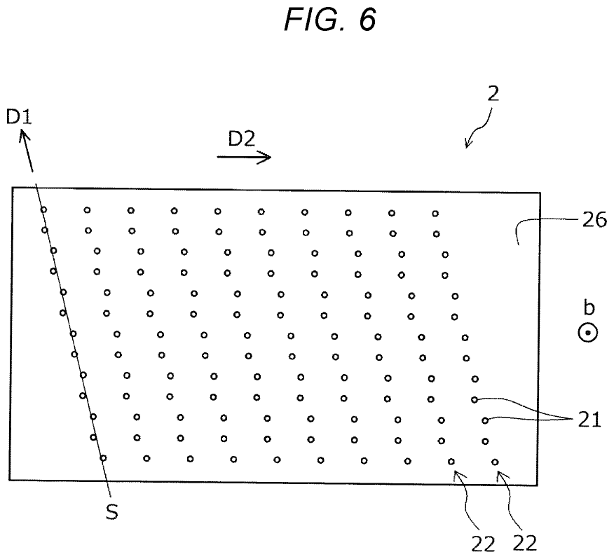

As below, a liquid ejection device 1 of Embodiment 2 will be explained with reference to FIG. 6. FIG. 6 corresponds to FIG. 2 in the liquid ejection device 1 of Embodiment 1. The liquid ejection device 1 of the embodiment is the same as the liquid ejection device 1 of Embodiment 1 except the configuration to be described. Accordingly, the liquid ejection device 1 of the embodiment has the same characteristics as the liquid ejection device 1 of Embodiment 1 except the parts to be described. In FIG. 6, the common component members with the above described Embodiment 1 have the same signs and the detailed description thereof will be omitted.

As shown in FIG. 2 etc., in the liquid ejection device 1 of Embodiment 1, the first nozzle holes 21 are linearly arranged along the direction D1 in each first nozzle row 22. On the other hand, as shown in FIG. 6, in the liquid ejection device 1 of the embodiment, the first nozzle holes 21 are arranged in a staggered manner with respect to the direction D1 in each first nozzle row 22. As described above, the first nozzle holes 21 may be arranged in a staggered manner with respect to a predetermined direction in the first nozzle row 22. Note that, in this case, the second distance L2 may be determined based on an imaginary line S on averages of the positions of the first nozzle holes 21 arranged in the staggered manner. Note that the first nozzle rows 22 may be arranged in a staggered manner with e.g., shifts about twice the hole diameter L3 of the first nozzle hole 21 with respect to the imaginary line S. Further, regarding the first nozzle rows 22, for example, the direction in which the first nozzle holes 21 are arranged or the imaginary line S is not necessarily completely linear, but may be curved. Note that the hole diameter L3 of the first nozzle hole 21 may vary due to manufacturing tolerances. It is preferable to suppress the variations to about twice or less and, if there are variations, an average value may be used as a reference.

### Embodiment 3

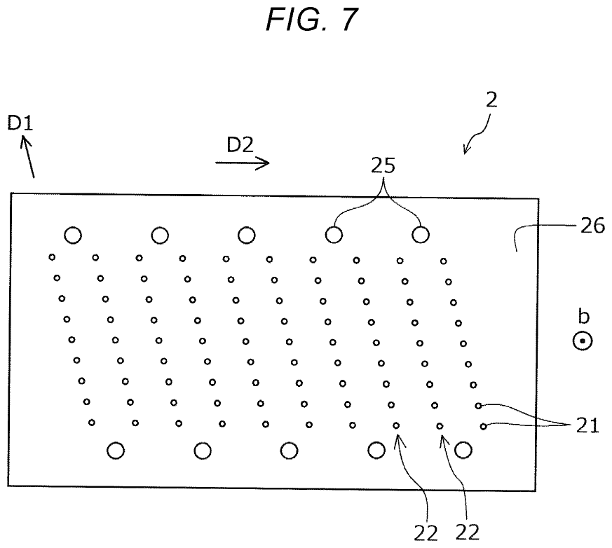

As below, a liquid ejection device 1 of Embodiment 3 will be explained with reference to FIG. 7. FIG. 7 corresponds to FIG. 2 in the liquid ejection device 1 of Embodiment 1. The liquid ejection device 1 of the embodiment is the same as the liquid ejection devices 1 of Embodiment 1 and Embodiment 2 except the configuration to be described. Accordingly, the liquid ejection device 1 of the embodiment has the same characteristics as the liquid ejection devices 1 of Embodiment 1 and Embodiment 2 except the parts to be described. In FIG. 7, the common component members with the above described Embodiment 1 and Embodiment 2 have the same signs and the detailed description thereof will be omitted.

As described above, in the liquid ejection devices 1 of Embodiment 1 and Embodiment 2, only the first nozzle holes 21 are provided as nozzle holes. On the other hand, as shown in FIG. 7, in the liquid ejection device 1 of the embodiment, second nozzle holes 25 are provided in addition to the first nozzle holes 21.

Specifically, as shown in FIG. 7, in the liquid ejection device 1 of the embodiment, in the ejection surface 26, the second nozzle holes 25 having different hole diameters from the first nozzle holes 21 are placed outside of the formation area of the first nozzle holes 21 as seen from the ejection direction b of the liquid 3. According to the configuration, foreign matter with dirt or the like removed from the object O by the liquid 3 ejected from the first nozzle holes 21 may be washed away from on the object O by the liquid 3 ejected from the second nozzle holes 25 placed around.

More specifically, in the liquid ejection device 1 of the embodiment, the hole diameter of the second nozzle hole 25 is larger than the hole diameter L3 of the first nozzle hole 21, a flow rate of the liquid 3 per unit time ejected from the second nozzle holes 25 is higher than a flow rate of the liquid 3 per unit time ejected from the first nozzle holes 21. Accordingly, for example, the liquid ejection device 1 of the embodiment may particularly effectively remove the foreign matter with dirt or the like attached to the object O by the liquid 3 discharged from the second nozzle holes 25. Note that, in the embodiment, the first nozzle holes 21 and the second nozzle holes 25 are formed in the ejection surface 26 formed by the same plate, however, the first nozzle holes 21 and the second nozzle holes 25 may be formed in different plates. Note that the flow rate here refers not to a flow rate from the single first nozzle hole 21 and a flow rate from the single second nozzle hole 25, but to a total flow rate from all first nozzle holes 21 and a total flow rate from all second nozzle holes 25.

The present disclosure is not limited to the above described embodiments, but may be realized in various configurations without departing from the scope thereof. The technical features in the embodiments corresponding to the technical features in the respective configurations described in SUMMARY can be appropriately replaced or combined in order to solve part or all of the above described problems or achieve part or all of the above described effects. Further, the technical features not described as essential features in the specification can be appropriately deleted. For example, a configuration not coupled to a pump or the like, but the liquid feed tube 9 connecting to the head part 2 may be directly attached to a water pipe and used.

What is claimed is:

1. A liquid ejection device comprising an ejector configured to eject a liquid in a continuous flow from an ejection surface of the ejector, form the continuous flow into droplets, and cause a collision with an object in a form of the droplets, wherein,
in the ejection surface, a plurality of first nozzle rows each including a plurality of first nozzle holes for ejecting the liquid arranged at first distances in a nozzle hole arrangement direction are arranged,
the plurality of first nozzle rows is arranged at second distances in a nozzle row arrangement direction crossing the nozzle hole arrangement direction, and
the second distance is equal to or more than twice the first distance.

2. The liquid ejection device according to claim 1, wherein
the first distance is equal to or more than ten times a hole diameter of the first nozzle hole.

3. The liquid ejection device according to claim 1, wherein
in the ejection surface, a ratio of a length in which the first nozzle holes are provided in the nozzle row arrangement direction to a length in which the first nozzle holes are provided in a direction orthogonal to the nozzle row arrangement direction is equal to or larger than 1.5.

4. The liquid ejection device according to claim 1, wherein
in the ejector, a rate of a formation area of the first nozzle holes to an area of the ejection surface is equal to or lower than 1%.

5. The liquid ejection device according to claim 1, wherein
a hole diameter of the first nozzle hole is equal to or smaller than 150 μm.

6. The liquid ejection device according to claim 1, wherein
in the ejection surface, second nozzle holes having different hole diameters from the first nozzle holes are placed outside of a formation area of the first nozzle holes as seen from an ejection direction of the liquid.

7. The liquid ejection device according to claim 6, wherein
a flow rate of the liquid per unit time ejected from the second nozzle holes is higher than a flow rate of the liquid per unit time ejected from the first nozzle holes.

1. A liquid ejection device comprising an ejector configured to eject a liquid in a continuous flow from an ejection surface of the ejector, form the continuous flow into droplets, and cause a collision with an object in a form of the droplets, wherein,
in the ejection surface, a plurality of first nozzle rows each including a plurality of first nozzle holes for ejecting the liquid arranged at first distances in a nozzle hole arrangement direction are arranged,
the plurality of first nozzle rows is arranged at second distances in a nozzle row arrangement direction crossing the nozzle hole arrangement direction, and
the second distance is equal to or more than twice the first distance.

2. The liquid ejection device according to claim 1, wherein
the first distance is equal to or more than ten times a hole diameter of the first nozzle hole.

3. The liquid ejection device according to claim 1, wherein
in the ejection surface, a ratio of a length in which the first nozzle holes are provided in the nozzle row arrangement direction to a length in which the first nozzle holes are provided in a direction orthogonal to the nozzle row arrangement direction is equal to or larger than 1.5.

4. The liquid ejection device according to claim 1, wherein
in the ejector, a rate of a formation area of the first nozzle holes to an area of the ejection surface is equal to or lower than 1%.

5. The liquid ejection device according to claim 1, wherein
a hole diameter of the first nozzle hole is equal to or smaller than 150 μm.

6. The liquid ejection device according to claim 1, wherein
in the ejection surface, second nozzle holes having different hole diameters from the first nozzle holes are placed outside of a formation area of the first nozzle holes as seen from an ejection direction of the liquid.

7. The liquid ejection device according to claim 6, wherein
a flow rate of the liquid per unit time ejected from the second nozzle holes is higher than a flow rate of the liquid per unit time ejected from the first nozzle holes.
